(19) United States
(12) Patent Application Publication
(10) Pub. No.: US 2014/0025362 A1
(43) Pub. Date: Jan. 23, 2014

(54) Methods for Semiconductor Processor Design and Verification

(71) Applicant: Paneve, LLC, Louisville, CO (US)

(72) Inventor: Steven J. Frank, Boulder, CO (US)

(21) Appl. No.: 13/938,562

(22) Filed: Jul. 10, 2013

Related U.S. Application Data
(60) Provisional application No. 61/669,805, filed on Jul. 10, 2012.

(51) Int. Cl. G06F 17/50

(52) U.S. Cl. CPC G06F 17/5022
USPC 703/13

(57) ABSTRACT

The invention provides in some aspects methods for semiconductor processor design and verification that include the steps of applying to each of a first simulator and a second simulator commonly-defined tests, comparing results of such execution as between the simulators, and generating an output indicative thereof. The first simulator simulates operation of the processor in accord with an architectural definition thereof, and the second simulator simulates operation of the processor in accord with a hardware definition thereof. The tests are defined in accord with one of those definitions, e.g., the hardware definition.

### BACKGROUND OF THE INVENTION

This application claims the benefit of filing of U.S. Patent Application Ser. No. 61/669,805, filed Jul. 10, 2012, entitled “Methods for Semiconductor Processor Design and Verification.”

The invention pertains to digital data processing and, more particularly, to the design, verification and fabrication of semiconductor chips.

The technical challenges of bringing a new semiconductor chip and, more particularly, a new processor to market are manifold. They include expertise in system architecture and in hardware design. The former concerns the functions and framework (e.g., instruction sets) that the processor, for example, will provide to manufacturers who incorporate it into their products and to the software developers who write code that run on it there. The later (i.e., the hardware design) concerns realizing those functions and that framework in silicon.

Expertise and follow-through in both disciplines is critical. A chip that is poorly architected may prove a detriment to manufacturers and software developers, alike, of they are forced to design (or redesign) their own products to work around chip shortcomings. Conversely, a well architected chip that is poorly executed in silicon may run so slowly or more consume so much power as to prove impractical.

Semiconductor manufacturers have largely worked to overcome these challenges by intensive verification regiments. Typically, these involve creating, in software, a virtual machine that executes in the manner defined in the architectural specification and running sequences of test instructions on that machine to verify that the architectural robustness and practicality. In parallel, hardware designers craft a hardware definition of the chip, e.g., at the gate-level (or a higher level of abstraction), to be embodied in silicon at the foundry, at the same time running tests against that definition on a suitable simulator—and, later in the fabrication process, on a field programmable gate array (if not an actual sample chip) configured in accord with that definition.

While the prior art verification regiments have proven reasonably successfully, they can prove inefficient and, worse, often do not fully test either the architecture or its ultimate realization in a chip.

An object of the invention is to provide improved methodologies for semiconductor chip design and fabrication.

A related object of the invention is to provide such methods as can be applied to processor chips and systems-on-a-chip (SoC).

A further related object of the invention is to provide improved semiconductor chips manufactured in accord with such methods.

### SUMMARY OF THE INVENTION

The foregoing and other objects are attained by the invention, which provides in some aspects methods for semiconductor processor design and verification that include the steps of applying to each of a first simulator and a second simulator commonly-defined tests, comparing results of such execution as between the simulators, and generating an output indicative thereof. The first simulator simulates operation of the processor in accord with an architectural definition thereof, and the second simulator simulates operation of the processor in accord with a hardware definition thereof. The tests are defined in accord with one of those definitions, e.g., the hardware definition.

Related aspects of the invention provide methods, e.g., as described above, in which each test of the set of commonly defined tests comprises a set of one or more instructions.

Further related aspects of the invention provide such methods in which the step of applying each test to each of the first simulator and the second simulator comprises applying at least one of the respective tests to the respective simulator via an application program interface (API) or other interface. In related aspects of the invention, each such test is applied to the first simulator via a test engine that can include that interface.

Other related aspects of the invention provide methods, e.g., as described above, in which the comparing step includes comparing with each other states of the processors simulated by each of the first and second simulators. Related aspects of the invention provide such methods in which that comparing step includes comparing with each other states of one or more simulated registers of that processor. Yet still further related aspects of the invention provide such methods in which that comparing step includes the step of comparing with each other one or more simulated outputs of that processor.

Still further related aspects of the invention provide such methods in which the step of applying each test to the simulators includes translating such a test from a language native to the second simulator to a language native to the first simulator.

Yet still further related aspects of the invention provide methods, e.g., as described above, in which the second simulator simulates operation of the processor in accord with a system-level hardware definition. In related aspects, the invention provides methods in which the second simulator comprises a SystemC simulator.

Further related aspects of the invention provide digital data processing systems for semiconductor processor design verification operating in accord with the methods above.

### BRIEF DESCRIPTION OF THE DRAWINGS

A more complete understanding of the invention may be attained by reference to the drawings, in which:

FIG. 1 depicts a system according to the invention.

### DETAILED DESCRIPTION OF THE ILLUSTRATED EMBODIMENT

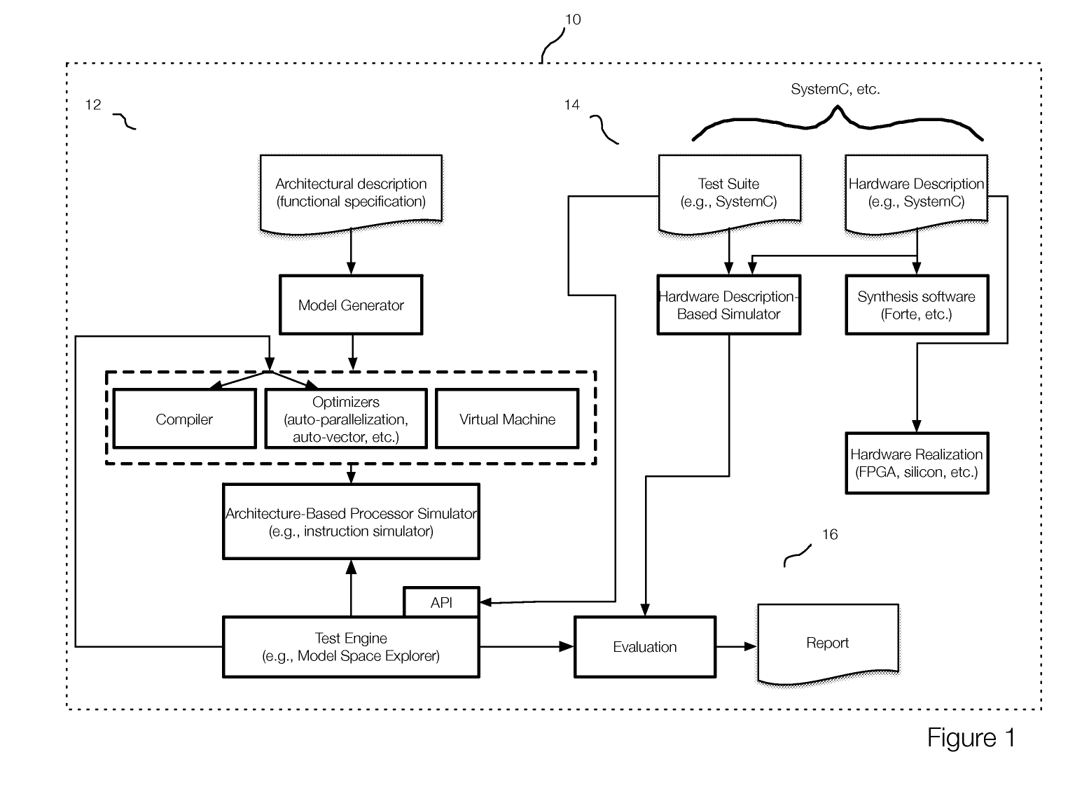

FIG. 1 depicts a system 10 for semiconductor chip (and, particularly, for example, semiconductor processor) design and verification according to one practice of the invention. The system includes a first collection of modules, generally identified in the drawing as 12, for architectural design and verification, and a second such collection, generally identified as 14, for hardware design, verification and fabrication.

An evaluation module 16 compares the state and/or results produced by a simulator in collection 12 (i.e., a simulator that simulates operation of the chip in accord with an architectural definition) with the state and/or results produced by a simulator in collection 14 (i.e., a simulator that simulates operation of the chip in accord with an architectural definition) in response to a common set of tests applied to them. In the illustrated embodiment, those common tests are generated from a definition that is in a language native to the simulator in collection 14 (but not to the simulator in collection 12). The tests are applied to the latter, for example, via an interface (such as an API) to a test engine in collection 12.

The module 16 outputs an indication of the similarity of the respective states and/or results of the simulators following application of the common tests, enabling the chip maker (or other) to discern whether a chip designed in accord with the architectural and hardware descriptions will function consistently and as expected from both architectural and hardware implementation perspectives.

With further reference to FIG. 1, the system 10 and, more particularly, the first collection of modules 12 includes a model generator 18 that generates a system “model” 20 (comprising a low level virtual machine 22, compiler 24 and optimizers 26) of a semiconductor chip, e.g., processor, being designed or simulated (hereinafter, “processor being designed” for simplicity and without loss of generality) based on an architectural description (or functional specification) 28. The collection 12 also includes an architecture-based simulator 30 and test engine 32 (including API 32A). The elements of collection 12 are coupled for communications as indicated in the drawings. They may be implemented on a host workstation, mainframe computer, desktop computer or other digital data processing device (collectively, “host digital data processor”) in view of the teachings hereof.

Illustrated model generator 18 may be of the conventional type known in the art suitable for, *inter alia*, facilitating functional simulation of an actual or proposed chip design based in an architectural description 28. In these regards, such an architectural description for a processor is one that specifies an instruction set, registers, cache structure, memory system, instruction cycle and/or instruction pipeline of the processor (or, to the extent relevant, other chip). It can be thought of as a functional description of the chip, specifying, for example, what instructions the processor will natively provide, what registers it will have and how they will used by the instructions, what on-board functions (such as vector processing) it will support, and so forth. Or, in still other terms, the operating system and application developers' view of the processor.

In these regards, the functional description that is the architectural description 28 differs from the hardware description 36 of the processor, which concerns itself more strictly with how those instructions, registers, and other functions will actually be realized, e.g., from the interconnection of logic gates to the placement and organization of higher-level modules comprising that logic. Further unlike the functional/architectural description, the hardware description 36 is rooted (at least at its lowest levels of abstraction) in the strict timing of interactions between gates, modules and so forth. Of course, those skilled in the art will appreciate that these characterizations of architectural and hardware descriptions, as well as the their differences, are necessarily made with a broad brush and that in practice there may be some overlap between them.

An example of a model generator 18 suitable for practice of the invention is the Teraptor product commercially available from Sankhya Technologies Private Limited. That and ancillary products from that same vendor utilize modeling languages known as SSDL and SMDL (that are unique, for example, from hardware modeling languages such as SystemC) for definition of the architecture of processor and processor systems.

As noted, the model generator 18 generates a system model 20—here, comprising a low level virtual machine 22, compiler 24 and optimizers 26—of the processor being designed. The compiler 24 is a conventional compiler of the type known in the art, albeit adapted by the model generator 18 to compile code written in accord with the architectural description 28 (i.e., source code intended for execution on the virtual machine 22) for execution on the host digital data processor. In the illustrated embodiment, the compiler 24 is based on the GCC compiler published by the LLVM Project (again, as adapted to compile code in accord with architectural description 28).

The virtual machine 22 is a virtual machine of the type known in the art executable, e.g., on the host digital data processor, and suitable when configured by the model generator 18 in accord with the architectural description 28 to execute code generated by compiler 24 and to reflect the state of the processor being designed. Illustrated virtual machine 22 can be based on the open source VMKit project or other such framework suited to utilize code generated by compiler 24, e.g., in view of optimizations by optimizers 26.

Optimizers 26 comprise auto-parallelization, auto-vectoring and other pre-processors (and/or post-processors) that manipulate source code to be compiled by compiler 24 (and/or object, intermediate or other code generated by that compiler 24) to insure that code generated by it for execution on the virtual machine 22 appropriately conforms to the architectural description 28. Instead of and/or in addition to conformance, such pre-processing (and/or post-processing) can serve to optimize the generated code to mirror optimizations that are expected be employed in code running on the processor being designed and/or to improve execution of the code on the host digital data processor.

Simulator 30 simulates operation of the processor being designed in accord with architectural definition 28 and, more particularly, executes on virtual machine 22 test or other code compiled by compiler 24 and optimized by optimizers 26. The simulator 30 comprises an instantiation of that virtual machine executing on the host digital data processor and operating from initial conditions defined through action of the model generator 18 and/or test engine 32.

Test engine 32 comprises a test harness or framework of the type commonly known in the art, as adapted in accord with the teachings hereof, to (i) apply sequences of test instructions in a test suite 40 specified in connection with the hardware description 36 (received from simulator 38) to compiler 24 (and optimizers 26) for compilation and generation of simulator 30 based on virtual machine 22, (ii) invoke execution of the simulator (including those test instructions) over a parameter space that is also specified by those instructions and/or that suite 40,(iii) query simulator for its state (and, therefor, the predicted state of the processor being designed) and/or for any output of that execution, and (iv) pass that state and/or output on for evaluation in comparison to results of execution of a like sequence of test instructions by simulator 38. As used here, the “state” of the simulator refers to that status of registers, cache, etc., of the processor being simulated.

An example of a test engine 32 suitable for practice of the invention is the Model Space Explorer (MSE) commercially available from Sankhya Technologies Private Limited (for use in connection with the aforementioned Teraptor product), as adapted in accord with the teachings hereof. Such adaptation includes incorporation of an interface 32A, such as an applications program interface, suitable for invocation by simulator 38 in order to apply sequences of test instructions in the test suite 40 to the simulator 30.

With further reference to FIG. 1, the second collection of modules 14 (which may also be implemented on the host digital data processor or another such device in the conventional manner known in the the art, as adapted in view of the teachings hereof) includes a synthesizer 34 that generates, from a hardware description 36 of the semiconductor processor being designed, “technology files” of the conventional kind known in the art specifying hardware specific-parameters for FPGA, semiconductor chips, or hardware implementations. These may be used with suitable tools (not shown)—such as Xilinx's “Synplify” product family, Cadence's SOC Encounter place-and-route product, and so forth—to realize hardware instances of the semiconductor processor.

The collection 14 also includes a simulator 38 that simulates operation of the processor being designed in accord with hardware definition 36 and, more particularly, that (i) executes in a manner specified in connection with the hardware description 36 machine code form is instructions specified in connection with the architectural description 28, and (ii) reflects the state of the processor being designed before, during and after such execution. Again, as above, the “state” of the simulator refers to that status of registers, cache, etc., of the processor being simulated.

Simulator 38 of the illustrated embodiment is particularly configured to (i) execute sequences of test instructions in test suite 40, (ii) query simulator 38 for its state and/or for any output of that execution, and (iii) pass that state and/or output on for evaluation in comparison to results of execution of a like sequence of test instructions by simulator 30 the state of the simulated processor and/or output of execution of such sequences, (iv) apply like instructions to interface 32A of test engine 32 for application to simulator 30.

Hardware description language and test suite 40 of the illustrated embodiment comprise source code in a common language, SystemC. In other embodiments, other hardware description languages, such as SystemVerilog, may be used instead. Regardless, these hardware description languages differ from the modeling languages such as SSDL and SMDL employed in architectural description 28. Correspondingly, illustrated simulator 38 comprises a SystemC Simulator, as adapted in accord with the teachings hereof. Other simulators of the type known in the art suitable for simulating operation of the processor being designed in accord with the hardware description 36 may be used instead, again, as adapted in accord with the teachings hereof.

Test suite 40 comprises, as evident from the description above, sequences of instructions intended to exercise functionality of the respective simulators 30, 38 and more aptly that of the processor being designed. In addition, the suite specifies for each such sequence a parameter space over which the simulator is to be exercised in execution of that sequence. Test suite 40 of the illustrated embodiment is defined (e.g., in SystemC) in the conventional manner known in the art, as adapted in accord with the teachings hereof, e.g., taking into account that the test sequences are intended to exercise functionality specified in both the hardware definition and architectural description of the processor being developed.

Evaluation module 16 receives state and other information (e.g., the output of test results) from test engine 32 and simulator 38 following execution of each like sequence of test instructions and compares them (e.g., outputs, register and/or contents of the simulated processor from simulator 30 with those of the simulated processor from simulator 38) to discern whether a chip designed in accord with the architectural description 28 and hardware description 36 will function consistently and as expected from both architectural and hardware implementation perspectives. Module 16 generates a report or other output indicative of the results of that comparison, along, for example, with an indication of the respective sequence of instructions executed during the test.

Described above are systems and methods of operation meeting the objects above, among others. It will be appreciated that the embodiments described here are merely examples of the invention and that other embodiments incorporating changes therein fall within the scope thereof. Thus, for example, it will appreciated that the one or more functions of the model 20 and simulator 30 may be incorporated in a single module, such as, for example, an interpreter. It will be further appreciated, for example, that the collections of modules 12, 14 may execute on the same or different digital data processors, networked or otherwise.

In view of the foregoing, what I/we claim is:

1. A method for semiconductor processor design and verification comprising the steps of:
A. applying to each of a first simulator and a second simulator each test of a plurality of commonly-defined tests, each comprising a sequence of one of more instructions,
B. comparing results of such execution as between the simulators, and generating an output indicative thereof,
C. wherein the first simulator simulates operation of the processor in accord with an architectural definition thereof, and the second simulator simulates operation of the processor in accord with a hardware definition thereof, and
D. wherein the tests are defined in accord with one of the hardware definition.

2. The method of claim 1, wherein the step of applying each test to each of the first simulator and the second simulator comprises applying at least one of the respective tests to the respective simulator via an application program interface (API) or other interface.

3. The method of claim 1, wherein the comparing step includes comparing with each other states of the processors simulated by each of the first and second simulators.

4. The method of claim 1, wherein the comparing step includes comparing with each other states of one or more simulated registers of that processor.

5. The method of claim 4, wherein the comparing step includes the step of comparing with each other one or more simulated outputs of that processor.

6. The method of claim 1, wherein the step of applying each test to the simulators includes translating such a test from a language native to the second simulator to a language native to the first simulator.

7. The method of claim 1, wherein the second simulator simulates operation of the processor in accord with a system-level hardware definition.

8. The method of claim 7, wherein the second simulator comprises a SystemC simulator.

9. A digital data processing system for semiconductor processor design verification operating in accord with the methods of any of claims 1-8.
